(19) United States
(12) Patent Application Publication
(10) Pub. No.: US 2004/0010594 A1
(43) Pub. Date: Jan. 15, 2004

(54) Virtualizing the security parameter index, marker key, frame key, and verification tag

(75) Inventors: William Todd Boyd, Poughkeepsie, NY (US); Douglas J. Joseph, Danbury, CT (US); Renato John Recio, Austin, TX (US)

Correspondence Address: Duke W. Yee, Carstens,, Yee & Cahoon, LLP, P.O. Box 802334, Dallas, TX, 75380, US

(73) Assignee: International Business Machines Corporation, Armonk, NY

(21) Appl. No.: 10/195,189

(22) Filed: Jul. 11, 2002

(51) Int. Cl. G06F 15/167; G06F 15/16

(52) U.S. Cl. 709/227; 709/212

(57) ABSTRACT

The present invention provides a method, computer program product, and distributed data processing system for virtualizing the Queue Pairs used by an Internet Protocol Suite Offload Engine (IPSOE). The distributed data processing system comprises end nodes, switches, routers, and links interconnecting the components. The end nodes use send and receive queue pairs to transmit and receive messages. The end nodes segment the message into frames and transmit the frames over the links. The switches and routers interconnect the end nodes and route the frames to the appropriate end nodes. The end nodes reassemble the frames into a message at the destination.

The present invention provides a mechanism for virtualizing the Queue Pairs (QPs) used by an IP Suite Offload Engine (IPSOE). Using the mechanism provided in the present invention when a TCP connection is torn down, its QP resources can immediately be reused on a new connection, without going through a Time Wait period.

### BACKGROUND OF THE INVENTION

1. Technical Field

The present invention generally relates to communication protocols between a host computer and an input/output (I/O) device. More specifically, the present invention provides a method by which the Queue Pair resources used by a Remote Direct Memory Access over Transmission Control Protocol can be virtualized.

2. Description of Related Art

In an Internet Protocol (IP) Network, the software provides a message passing mechanism that can be used to communicate with Input/Output devices, general purpose computers (host), and special purpose computers. The message passing mechanism consists of a transport protocol, an upper level protocol, and an application programming interface. The key standard transport protocols used on IP networks today are the Transmission Control Protocol (TCP) and the User Datagram Protocol (UDP). TCP provides a reliable service and UDP provides an unreliable service. In the future the Stream Control Transmission Protocol (SCTP) will also be used to provide a reliable service. Processes executing on devices or computers access the IP network through Upper Level Protocols, such as Sockets, iSCSI, and Direct Access File System (DAFS).

Unfortunately the TCP/IP software consumes a considerable amount of processor and memory resources. This problem has been covered extensively in the literature (see J. Kay, J. Pasquale, “Profiling and reducing processing overheads in TCP/IP”, IEEE/ACM Transactions on Networking, Vol 4, No. 6, pp. 817-828, December 1996; and D. D. Clark, V. Jacobson, J. Romkey, H. Salwen, “An analysis of TCP processing overhead”, IEEE Communications Magazine, volume: 27, Issue: 6, June 1989, pp 23-29). In the future the network stack will continue to consume excessive resources for several reasons, including: increased use of networking by applications; use of network security protocols; and the underlying fabric bandwidths are increasing at a higher rate than microprocessor and memory bandwidths. To address this problem the industry is offloading the network stack processing to an IP Suite Offload Engine (IPSOE).

There are two offload approaches being taken in the industry. The first approach uses the existing TCP/IP network stack, without adding any additional protocols. This approach can offload TCP/IP to hardware, but unfortunately does not remove the need for receive side copies. As noted in the papers above, copies are one of the largest contributors to CPU utilization. To remove the need for copies, the industry is pursuing the second approach that consists of adding Framing, Direct Data Placement (DDP), and Remote Direct Memory Access (RDMA) over the TCP and SCTP protocols. The IP Suite Offload Engine (IPSOE) required to support these two approaches is similar, the key difference being that in the second approach the hardware must support the additional protocols.

The IPSOE provides a message passing mechanism that can be used by sockets, iSCSI, and DAFS to communicate between nodes. Processes executing on host computers, or devices, access the IP network by posting send/receive messages to send/receive work queues on an IPSOE. These processes also are referred to as “consumers”.

The send/receive work queues (WQ) are assigned to a consumer as a queue pair (QP). The messages can be sent over several different transport types: traditional TCP, RDMA TCP, UDP, or SCTP. Consumers retrieve the results of these messages from a completion queue (CQ) through IPSOE send and receive work completion (WC) queues. The source IPSOE takes care of segmenting outbound messages and sending them to the destination. The destination IPSOE takes care of reassembling inbound messages and placing them in the memory space designated by the destination's consumer. These consumers use IPSO verbs to access the functions supported by the IPSOE. The software that interprets verbs and directly accesses the IPSOE is known as the IPSO interface (IPSOI).

Today the host CPU performs most of IP suite processing. IP Suite Offload Engines offer a higher performance interface for communicating to other general purpose computers and I/O devices. A single IPSOE supports a fixed number of QPs. When a connection is destroyed, the QP associated with the connection is not available for use on another connection until a TCP Time-Wait period has expired. Short lived connections can cause the IPSOE to completely run out of QP resources. That is, short lived connections can place all the QPs supported by the IPSOE in the Time Wait state, thereby making them, and the IPSOE, unavailable for use.

Therefore, a simple mechanism is needed to virtualize the Queue Pair (QP) used by a specific TCP connection and allow QPs to remain available immediately after TCP connection destruction.

### SUMMARY OF THE INVENTION

The present invention provides a method, computer program product, and distributed data processing system for virtualizing the Queue Pairs used by an Internet Protocol Suite Offload Engine (IPSOE). The distributed data processing system comprises end nodes, switches, routers, and links interconnecting the components. The end nodes use send and receive queue pairs to transmit and receive messages. The end nodes segment the message into frames and transmit the frames over the links. The switches and routers interconnect the end nodes and route the frames to the appropriate end nodes. The end nodes reassemble the frames into a message at the destination.

The present invention provides a mechanism for virtualizing the Queue Pairs (QPs) used by an IP Suite Offload Engine (IPSOE). Using the mechanism provided in the present invention when a TCP connection is torn down, its QP resources can immediately be reused on a new connection, without going through a Time Wait period.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a diagram illustrating a distributed computer system in accordance with a preferred embodiment of the present invention;

FIG. 2 depicts a functional block diagram illustrating a host processor node in accordance with a preferred embodiment of the present invention;

FIG. 3A depicts a diagram illustrating a IPSOE in accordance with a preferred embodiment of the present invention;

FIG. 3B depicts a diagram illustrating a switch in accordance with a preferred embodiment of the present invention;

FIG. 3C depicts a diagram illustrating a router in accordance with a preferred embodiment of the present invention;

FIG. 4 depicts a diagram illustrating processing of work requests in accordance with a preferred embodiment of the present invention;

FIG. 5 depicts a diagram illustrating a portion of a distributed computer system in accordance with a preferred embodiment of the present invention in which a TCP or SCTP transport is used;

FIG. 6 depicts a diagram illustrating a data frame in accordance with a preferred embodiment of the present invention;

FIG. 7 depicts a diagram illustrating a portion of a distributed computer system in accordance with a preferred embodiment of the present invention;

FIG. 8 depicts a diagram illustrating the network addressing used in a distributed networking system in accordance with the present invention;

FIG. 9 depicts a diagram illustrating a layered communication architecture used in a preferred embodiment of the present invention;

FIG. 10 depicts a diagram illustrating one embodiment of a layered architecture in accordance with the present invention;

FIG. 11 depicts a schematic diagram illustrating the operation of Queue Pair look-up in accordance with the present invention;

FIG. 12 depicts a flowchart illustrating the Queue Pair look-up process in accordance with the present invention;

FIG. 13 depicts a flowchart illustrating the process of connection tear-down in accordance with the present invention; and

FIG. 14 depicts a flowchart illustrating the process of the connection initialization in accordance with the present invention.

### DETAILED DESCRIPTION OF THE PREFERRED EMBODIMENT

The present invention provides a distributed computing system having end nodes, switches, routers, and links interconnecting these components. The end nodes can be Internet Protocol Suite Offload Engines or traditional host software based internet protocol suites. Each end node uses send and receive queue pairs to transmit and receive messages. The end nodes segment the message into frames and transmit the frames over the links. The switches and routers interconnect the end nodes and route the frames to the appropriate end node. The end nodes reassemble the frames into a message at the destination.

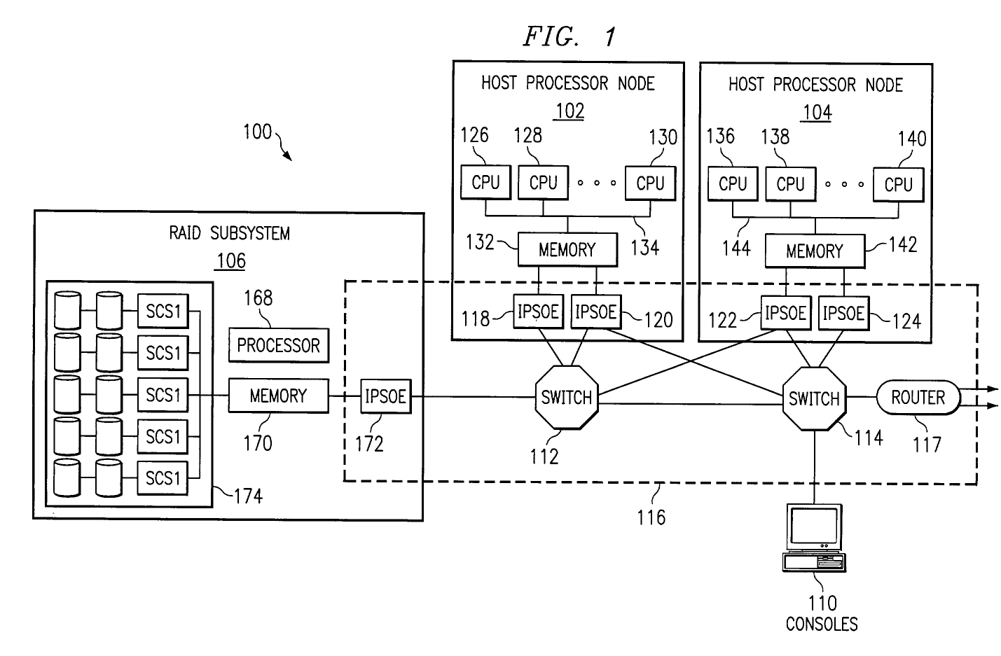

With reference now to the figures and in particular with reference to FIG. 1, a diagram of a distributed computer system is illustrated in accordance with a preferred embodiment of the present invention. The distributed computer system represented in FIG. 1 takes the form of an internet protocol network (IP net) 100 and is provided merely for illustrative purposes, and the embodiments of the present invention described below can be implemented on computer systems of numerous other types and configurations. For example, computer systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by an internet or intranet.

IP Net 100 is a high-bandwidth, low-latency network interconnecting nodes within the distributed computer system. A node is any component attached to one or more links of a network and forming the origin and/or destination of messages within the network. In the depicted example, IP Net 100 includes nodes in the form of host processor node 102, host processor node 104, and redundant array independent disk (RAID) subsystem node 106. The nodes illustrated in FIG. 1 are for illustrative purposes only, as IP Net 100 can connect any number and any type of independent processor nodes, storage nodes, and special purpose processing nodes. Any one of the nodes can function as an endnode, which is herein defined to be a device that originates or finally consumes messages or frames in IP Net 100.

In one embodiment of the present invention, an error handling mechanism in distributed computer systems is present in which the error handling mechanism allows for TCP or SCTP communication between end nodes in a distributed computing system, such as IP Net 100.

A message, as used herein, is an application-defined unit of data exchange, which is a primitive unit of communication between cooperating processes. A frame is one unit of data encapsulated by Internet Protocol Suite headers and/or trailers. The headers generally provide control and routing information for directing the frame through IP Net 100. The trailer generally contains control and cyclic redundancy check (CRC) data for ensuring frames are not delivered with corrupted contents.

Within a distributed computer system, IP Net 100 contains the communications and management infrastructure supporting various forms of traffic, such as storage, interprocess communications (IPC), file access, and sockets. The IP Net 100 shown in FIG. 1 includes a switched communications fabric 116, which allows many devices to concurrently transfer data with high-bandwidth and low latency in a secure, remotely managed environment. Endnodes can communicate over multiple ports and utilize multiple paths through the IP Net fabric. The multiple ports and paths through the IP Net shown in FIG. 1 can be employed for fault tolerance and increased bandwidth data transfers.

The IP Net 100 in FIG. 1 includes switch 112, switch 114, and router 117. A switch is a device that connects multiple links together and allows routing of frames from one link to another link using the layer 2 destination address field. When the Ethernet is used as the link, the destination field is known as the Media Access Control (MAC) address. A router is a device that routes frames based on the layer 3 destination address field. When Internet Protocol (IP) is used as the layer 3 protocol, the destination address field is an IP address.

In one embodiment, a link is a full duplex channel between any two network fabric elements, such as endnodes, switches, or routers. Example suitable links include, but are not limited to, copper cables, optical cables, and printed circuit copper traces on backplanes and printed circuit boards.

For reliable service types (TCP and SCTP), endnodes, such as host processor endnodes and I/O adapter endnodes, generate request frames and return acknowledgment frames. Switches and routers pass frames along, from the source to the destination.

In IP Net 100 as illustrated in FIG. 1, host processor node 102, host processor node 104, and RAID subsystem 106 include at least IPSOE to interface to IP Net 100. In one embodiment, each IPSOE is an endpoint that implements the IPSOI in sufficient detail to source or sink frames transmitted on IP Net fabric 100. Host processor node 102 contains IPSOEs in the form of host IPSOE 118 and IPSOE 120. Host processor node 104 contains IPSOE 122 and IPSOE 124. Host processor node 102 also includes central processing units 126-130 and a memory 132 interconnected by bus system 134. Host processor node 104 similarly includes central processing units 136-140 and a memory 142 interconnected by a bus system 144.

IP Suite Offload Engine 118 provides a connection to switch 112, while IP Suite Offload Engine 124 provides a connection to switch 114, and IP Suite Offload Engines 120 and 122 provide a connection to switches 112 and 114.

In one embodiment, an IP Suite Offload Engine is implemented in hardware or a combination of hardware and offload microprocessor(s). In this implementation, IP suite processing is offloaded to the IPSOE. This implementation also permits multiple concurrent communications over a switched network without the traditional overhead associated with communicating protocols. In one embodiment, the IPSOEs and IP Net 100 in FIG. 1 provide the consumers of the distributed computer system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers.

In this example, RAID subsystem node 106 in FIG. 1 includes a processor 168, a memory 170, an IP Suite Offload Engine (IPSOE) 172, and multiple redundant and/or striped storage disk unit 174.

IP Net 100 handles data communications for storage, interprocessor communications, file accesses, and sockets. IP Net 100 supports high-bandwidth, scalable, and extremely low latency communications. User clients can bypass the operating system kernel process and directly access network communication components, such as IPSOEs, which enable efficient message passing protocols. IP Net 100 is suited to current computing models and is a building block for new forms of storage, cluster, and general networking communication. Further, IP Net 100 in FIG. 1 allows storage nodes to communicate among themselves or communicate with any or all of the processor nodes in a distributed computer system. With storage attached to the IP Net 100, the storage node has substantially the same communication capability as any host processor node in IP Net 100.

In one embodiment, the IP Net 100 shown in FIG. 1 supports channel semantics and memory semantics. Channel semantics is sometimes referred to as send/receive or push communication operations. Channel semantics are the type of communications employed in a traditional I/O channel where a source device pushes data and a destination device determines a final destination of the data. In channel semantics, the frame transmitted from a source process specifies a destination processes' communication port, but does not specify where in the destination processes' memory space the frame will be written. Thus, in channel semantics, the destination process pre-allocates where to place the transmitted data.

In memory semantics, a source process directly reads or writes the virtual address space of a remote node destination process. The remote destination process need only communicate the location of a buffer for data, and does not need to be involved in the transfer of any data. Thus, in memory semantics, a source process sends a data frame containing the destination buffer memory address of the destination process. In memory semantics, the destination process previously grants permission for the source process to access its memory.

Channel semantics and memory semantics are typically both necessary for storage, cluster, and general networking communications. A typical storage operation employs a combination of channel and memory semantics. In an illustrative example storage operation of the distributed computer system shown in FIG. 1, a host processor node, such as host processor node 102, initiates a storage operation by using channel semantics to send a disk write command to the RAID subsystem IPSOE 172. The RAID subsystem examines the command and uses memory semantics to read the data buffer directly from the memory space of the host processor node. After the data buffer is read, the RAID subsystem employs channel semantics to push an I/O completion message back to the host processor node.

In one exemplary embodiment, the distributed computer system shown in FIG. 1 performs operations that employ virtual addresses and virtual memory protection mechanisms to ensure correct and proper access to all memory. Applications running in such a distributed computer system are not required to use physical addressing for any operations.

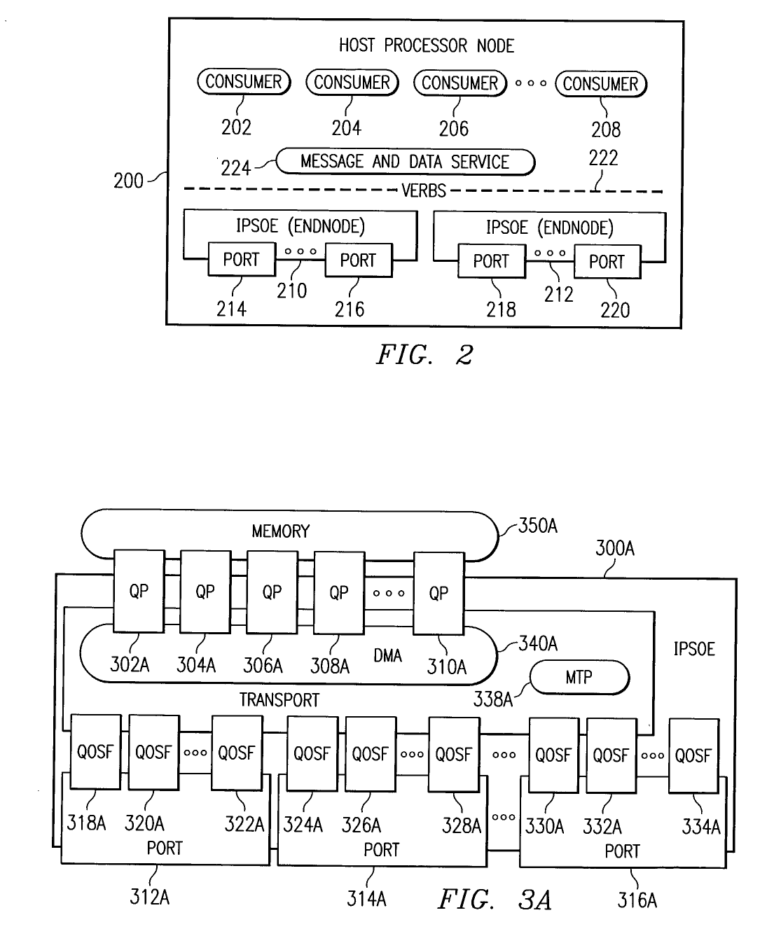

Turning next to FIG. 2, a functional block diagram of a host processor node is depicted in accordance with a preferred embodiment of the present invention. Host processor node 200 is an example of a host processor node, such as host processor node 102 in FIG. 1. In this example, host processor node 200 shown in FIG. 2 includes a set of consumers 202-208, which are processes executing on host processor node 200. Host processor node 200 also includes IP Suite Offload Engine (IPSOE) 210 and IPSOE 212. IPSOE 210 contains ports 214 and 216 while IPSOE 212 contains ports 218 and 220. Each port connects to a link. The ports can connect to one IP Net subnet or multiple IP Net subnets, such as IP Net 100 in FIG. 1.

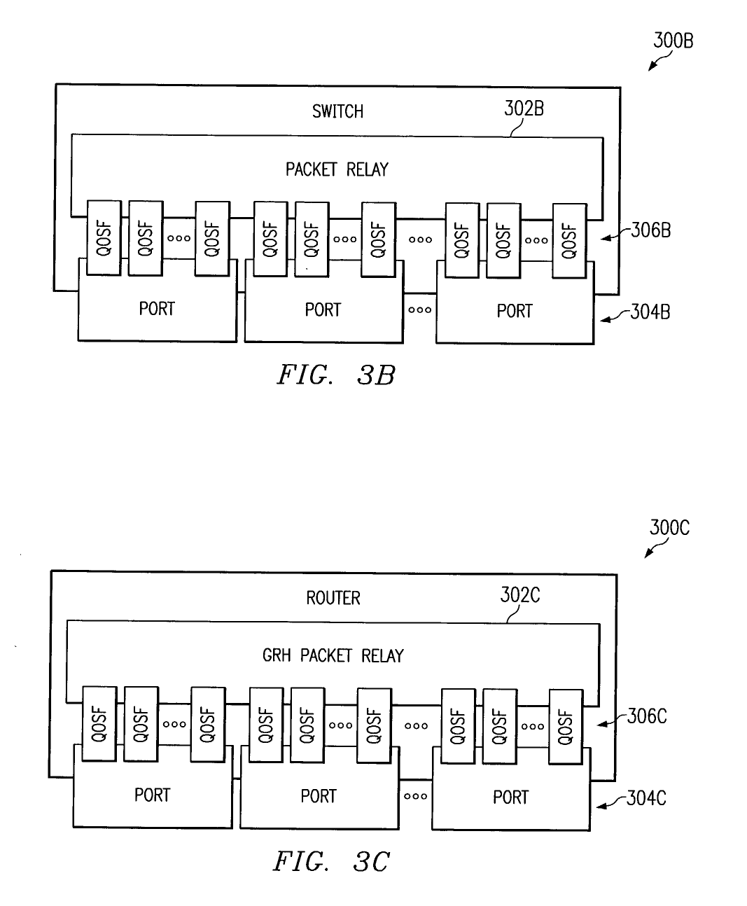

Consumers 202-208 transfer messages to the IP Net via the verbs interface 222 and message and data service 224. A verbs interface is essentially an abstract description of the functionality of an IP Suite Offload Engine. An operating system may expose some or all of the verb functionality through its programming interface. Basically, this interface defines the behavior of the host. Additionally, host processor node 200 includes a message and data service 224, which is a higher-level interface than the verb layer and is used to process messages and data received through IPSOE 210 and IPSOE 212. Message and data service 224 provides an interface to consumers 202-208 to process messages and other data. With reference now to FIG. 3A, a diagram of an IP Suite Offload Engine is depicted in accordance with a preferred embodiment of the present invention. IP Suite Offload Engine 300A shown in FIG. 3A includes a set of queue pairs (QPs) 302A-310A, which are used to transfer messages to the IPSOE ports 312A-316A. Buffering of data to IPSOE ports 312A-316A is channeled using the network layer's quality of service field, for example the Traffic Class field in the IP Version 6 specification, 318A-334A. Each network layer quality of service field has its own flow control. IETF standard network protocols are used to configure the link and network addresses of all IP Suite Offload Engine ports connected to the network. Two such protocols are Address Resolution Protocol (ARP) and Dynamic Host Configuration Protocol. Memory translation and protection (MTP) 338A is a mechanism that translates virtual addresses to physical addresses and validates access rights. Direct memory access (DMA) 340A provides for direct memory access operations using memory 342A with respect to queue pairs 302A-310A.

A single IP Suite Offload Engine, such as the IPSOE 300A shown in FIG. 3A, can support thousands of queue pairs. Each queue pair consists of a send work queue (SWQ) and a receive work queue (RWQ). The send work queue is used to send channel and memory semantic messages. The receive work queue receives channel semantic messages. A consumer calls an operating-system specific programming interface, which is herein referred to as verbs, to place work requests (WRs) onto a work queue.

FIG. 3B depicts a switch 300B in accordance with a preferred embodiment of the present invention. Switch 300B includes a frame relay 302B in communication with a number of ports 304B through link or network layer quality of service fields such as IP version 4's Type of Service field 306B. Generally, a switch such as switch 300B can route frames from one port to any other port on the same switch.

Similarly, FIG. 3C depicts a router 300C according to a preferred embodiment of the present invention. Router 300C includes a frame relay 302C in communication with a number of ports 304C through network layer quality of service fields such as IP version 4's Type of Service field 306C. Like switch 300B, router 300C will generally be able to route frames from one port to any other port on the same router.

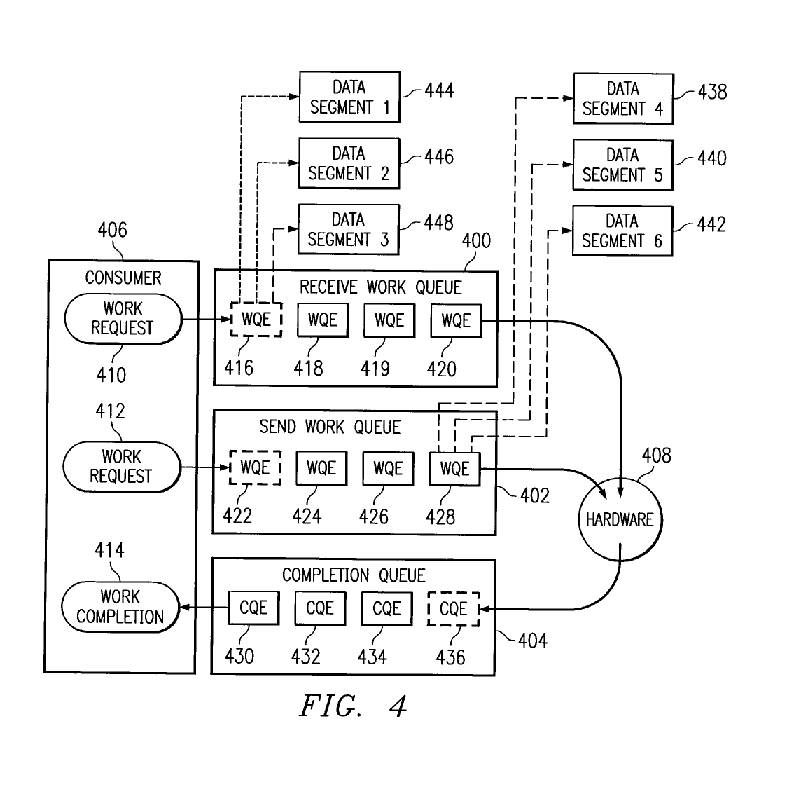

With reference now to FIG. 4, a diagram illustrating processing of work requests is depicted in accordance with a preferred embodiment of the present invention. In FIG. 4, a receive work queue 400, send work queue 402, and completion queue 404 are present for processing requests from and for consumer 406. These requests from consumer 402 are eventually sent to hardware 408. In this example, consumer 406 generates work requests 410 and 412 and receives work completion 414. As shown in FIG. 4, work requests placed onto a work queue are referred to as work queue elements (WQEs).

Send work queue 402 contains work queue elements (WQEs) 422-428, describing data to be transmitted on the IP Net fabric. Receive work queue 400 contains work queue elements (WQEs) 416-420, describing where to place incoming channel semantic data from the IP Net fabric. A work queue element is processed by hardware 408 in the IPSOE.

The verbs also provide a mechanism for retrieving completed work from completion queue 404. As shown in FIG. 4, completion queue 404 contains completion queue elements (CQEs) 430-436. Completion queue elements contain information about previously completed work queue elements. Completion queue 404 is used to create a single point of completion notification for multiple queue pairs. A completion queue element is a data structure on a completion queue. This element describes a completed work queue element. The completion queue element contains sufficient information to determine the queue pair and specific work queue element that completed. A completion queue context is a block of information that contains pointers to, length, and other information needed to manage the individual completion queues.

Example work requests supported for the send work queue 402 shown in FIG. 4 are as follows. A send work request is a channel semantic operation to push a set of local data segments to the data segments referenced by a remote node's receive work queue element. For example, work queue element 428 contains references to data segment 4 438, data segment 5 440, and data segment 6 442. Each of the send work request's data segments contains part of a virtually contiguous memory region. The virtual addresses used to reference the local data segments are in the address context of the process that created the local queue pair.

A remote direct memory access (RDMA) read work request provides a memory semantic operation to read a virtually contiguous memory space on a remote node. A memory space can either be a portion of a memory region or portion of a memory window. A memory region references a previously registered set of virtually contiguous memory addresses defined by a virtual address and length. A memory window references a set of virtually contiguous memory addresses that have been bound to a previously registered region.

The RDMA Read work request reads a virtually contiguous memory space on a remote endnode and writes the data to a virtually contiguous local memory space. Similar to the send work request, virtual addresses used by the RDMA Read work queue element to reference the local data segments are in the address context of the process that created the local queue pair. The remote virtual addresses are in the address context of the process owning the remote queue pair targeted by the RDMA Read work queue element.

A RDMA Write work queue element provides a memory semantic operation to write a virtually contiguous memory space on a remote node. For example, work queue element 416 in receive work queue 400 references data segment 1 444, data segment 2 446, and data segment 448. The RDMA Write work queue element contains a scatter list of local virtually contiguous memory spaces and the virtual address of the remote memory space into which the local memory spaces are written.

A RDMA FetchOp work queue element provides a memory semantic operation to perform an atomic operation on a remote word. The RDMA FetchOp work queue element is a combined RDMA Read, Modify, and RDMA Write operation. The RDMA FetchOp work queue element can support several read-modify-write operations, such as Compare and Swap if equal. The RDMA FetchOp is not included in current RDMA Over IP standardization efforts, but is described here, because it may be used as a value-add feature in some implementations.

A bind (unbind) remote access key (R_Key) work queue element provides a command to the IP Suite Offload Engine hardware to modify (destroy) a memory window by associating (disassociating) the memory window to a memory region. The R_Key is part of each RDMA access and is used to validate that the remote process has permitted access to the buffer.

In one embodiment, receive work queue 400 shown in FIG. 4 only supports one type of work queue element, which is referred to as a receive work queue element. The receive work queue element provides a channel semantic operation describing a local memory space into which incoming send messages are written. The receive work queue element includes a scatter list describing several virtually contiguous memory spaces. An incoming send message is written to these memory spaces. The virtual addresses are in the address context of the process that created the local queue pair.

For interprocessor communications, a user-mode software process transfers data through queue pairs directly from where the buffer resides in memory. In one embodiment, the transfer through the queue pairs bypasses the operating system and consumes few host instruction cycles. Queue pairs permit zero processor-copy data transfer with no operating system kernel involvement. The zero processor-copy data transfer provides for efficient support of high-bandwidth and low-latency communication.

When a queue pair is created, the queue pair is set to provide a selected type of transport service. In one embodiment, a distributed computer system implementing the present invention supports three types of transport services: TCP, SCTP, and UDP.

TCP and SCTP associate a local queue pair with one and only one remote queue pair. TCP and SCTP require a process to create a queue pair for each process that it is to communicate with over the IP Net fabric. Thus, if each of N host processor nodes contain P processes, and all P processes on each node wish to communicate with all the processes on all the other nodes, each host processor node requires P²×(N−1) queue pairs. Moreover, a process can associate a queue pair to another queue pair on the same IPSOE.

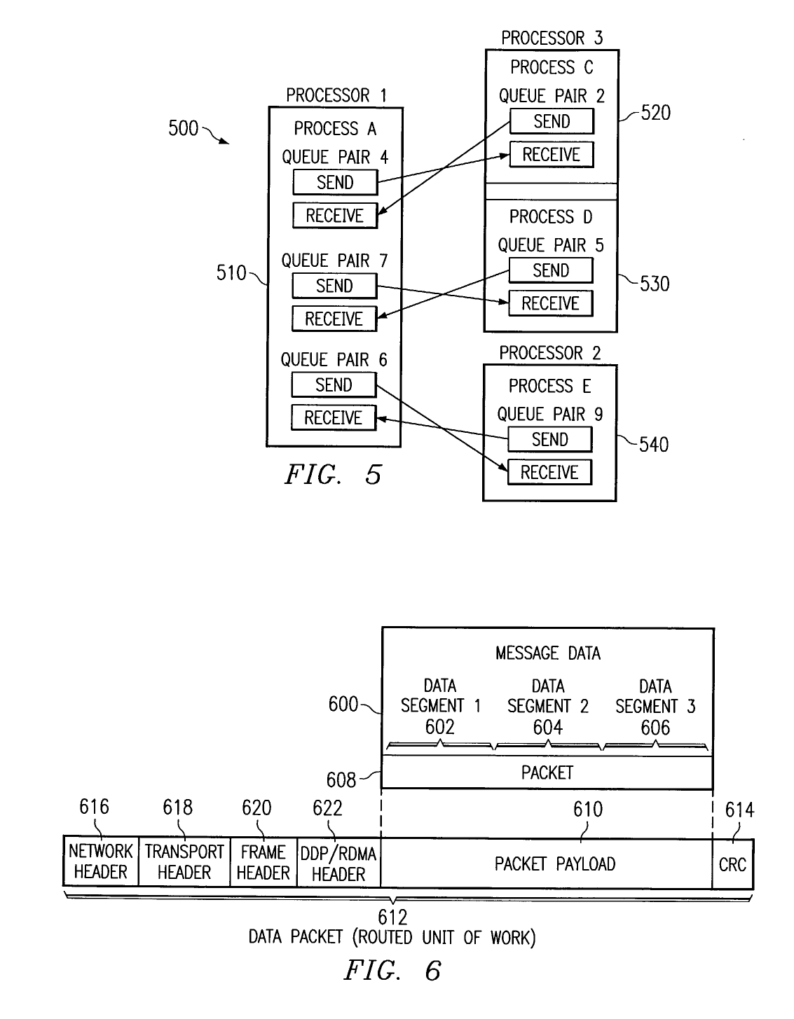

A portion of a distributed computer system employing TCP or SCTP to communicate between distributed processes is illustrated generally in FIG. 5. The distributed computer system 500 in FIG. 5 includes a host processor node 1, a host processor node 2, and a host processor node 3. Host processor node 1 includes a process A 510. Host processor node 2 includes a process C 520 and a process D 530. Host processor node 3 includes a process E 540.

Host processor node 1 includes queue pairs 4, 6 and 7, each having a send work queue and receive work queue. Host processor node 3 has a queue pair 9 and host processor node 2 has queue pairs 2 and 5. The TCP or SCTP of distributed computer system 500 associates a local queue pair with one an only one remote queue pair. Thus, the queue pair 4 is used to communicate with queue pair 2; queue pair 7 is used to communicate with queue pair 5; and queue pair 6 is used to communicate with queue pair 9.

A WQE placed on one send queue in a TCP or SCTP causes data to be written into the receive memory space referenced by a Receive WQE of the associated queue pair. RDMA operations operate on the address space of the associated queue pair.

In one embodiment of the present invention, the TCP or SCTP is made reliable because hardware maintains sequence numbers and acknowledges all frame transfers. A combination of hardware and IP Net driver software retries any failed communications. The process client of the queue pair obtains reliable communications even in the presence of bit errors, receive underruns, and network congestion. If alternative paths exist in the IP Net fabric, reliable communications can be maintained even in the presence of failures of fabric switches, links, or IP Suite Offload Engine ports.

In addition, acknowledgements may be employed to deliver data reliably across the IP Net fabric. The acknowledgement may, or may not, be a process level acknowledgement, i.e. an acknowledgement that validates that a receiving process has consumed the data. Alternatively, the acknowledgement may be one that only indicates that the data has reached its destination.

The UDP is connectionless. The UDP is employed by management applications to discover and integrate new switches, routers, and endnodes into a given distributed computer system. The UDP does not provide the reliability guarantees of the TCP or SCTP. The UDP accordingly operates with less state information maintained at each endnode.

Turning next to FIG. 6, an illustration of a data frame is depicted in accordance with a preferred embodiment of the present invention. A data frame is a unit of information that is routed through the IP Net fabric. The data frame is an endnode-to-endnode construct, and is thus created and consumed by endnodes. For frames destined to an IPSOE, the data frames are neither generated nor consumed by the switches and routers in the IP Net fabric. Instead for data frames that are destined to an IPSOE, switches and routers simply move request frames or acknowledgment frames closer to the ultimate destination, modifying the link header fields in the process. Routers, may modify the frame's network header when the frame crosses a subnet boundary. In traversing a subnet, a single frame stays on a single service level.

Message data 600 contains data segment 1 602, data segment 2 604, and data segment 3 606, which are similar to the data segments illustrated in FIG. 4. In this example, these data segments form a frame 608, which is placed into frame payload 610 within data frame 612. Additionally, data frame 612 contains CRC 614, which is used for error checking. Additionally, routing header 616 and transport header 618 are present in data frame 612. Routing header 616 is used to identify source and destination ports for data frame 612. Transport header 618 in this example specifies the sequence number and the source and destination port number for data frame 612. The sequence number is initialized when communication is established and increments by 1 for each byte of frame header, DDP/RDMA header, data payload, and CRC. Frame header 620 in this example specifies the destination queue pair number associated with the frame and the length of the Direct Data Placement and/or Remote Direct Memory Access (DDP/RDMA) header plus data payload plus CRC. DDP/RDMA header 622 specifies the message identifier and the placement information for the data payload. The message identifier is constant for all frames that are part of a message. Example message identifiers include: Send, Write RDMA, and Read RDMA.

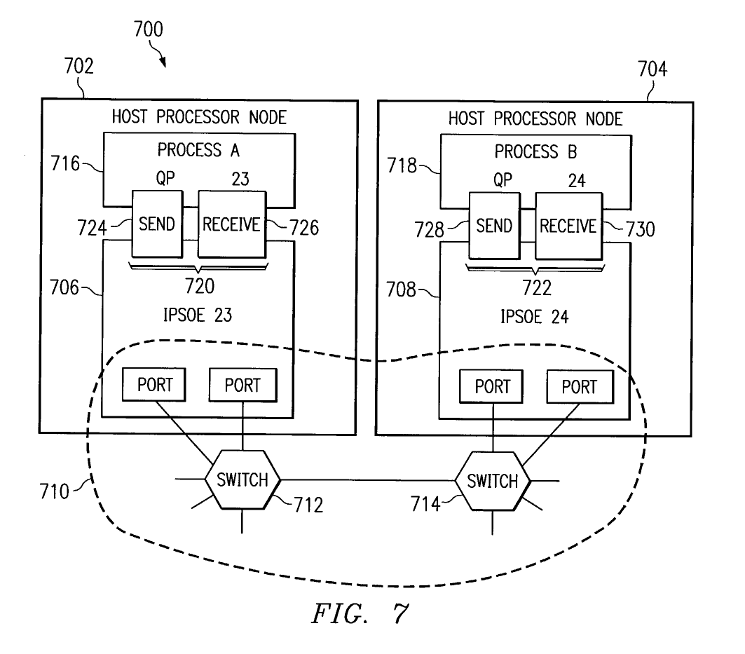

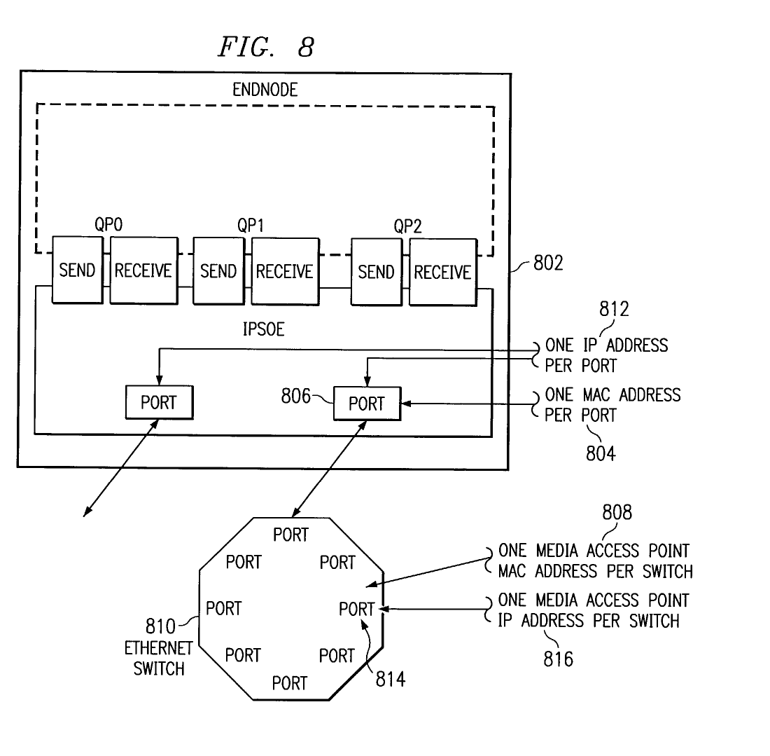

In FIG. 7, a portion of a distributed computer system is depicted to illustrate an example request and acknowledgment transaction. The distributed computer system in FIG. 7 includes a host processor node 702 and a host processor node 704. Host processor node 702 includes an IPSOE 706. Host processor node 704 includes an IPSOE 708. The distributed computer system in FIG. 7 includes a IP Net fabric 710, which includes a switch 712 and a switch 714. The IP Net fabric includes a link coupling IPSOE 706 to switch 712; a link coupling switch 712 to switch 714; and a link coupling IPSOE 708 to switch 714.

In the example transactions, host processor node 702 includes a client process A. Host processor node 704 includes a client process B. Client process A interacts with host IPSOE hardware 706 through queue pair 23. Client process B interacts with host IPSOE hardware 708 through queue pair 24. Queue pairs 23 and 24 are data structures that include a send work queue and a receive work queue.

Process A initiates a message request by posting work queue elements to the send queue of queue pair 23. Such a work queue element is illustrated in FIG. 4. The message request of client process A is referenced by a gather list contained in the send work queue element. Each data segment in the gather list points to part of a virtually contiguous local memory region, which contains a part of the message, such as indicated by data segments 1, 2, and 3, which respectively hold message parts 1, 2, and 3, in FIG. 4.

Hardware in host IPSOE 706 reads the work queue element and segments the message stored in virtual contiguous buffers into data frames, such as the data frame illustrated in FIG. 6. Data frames are routed through the IP Net fabric, and for reliable transfer services, are acknowledged by the final destination endnode. If not successfully acknowledged, the data frame is retransmitted by the source endnode. Data frames are generated by source endnodes and consumed by destination endnodes.

In reference to FIG. 8, a diagram illustrating the network addressing used in a distributed networking system is depicted in accordance with the present invention. A host name provides a logical identification for a host node, such as a host processor node or I/O adapter node. The host name identifies the endpoint for messages such that messages are destined for processes residing on an end node specified by the host name. Thus, there is one host name per node, but a node can have multiple IPSOEs.

A single link layer address (e.g. Ethernet Media Access Layer Address) 804 is assigned to each port 806 of a endnode component 802. A component can be an IPSOE, switch, or router. All IPSOE and router components have a MAC address. A media access point on a switch is also assigned a MAC address.

One network address (e.g. IP Address) 812 is assigned to each each port 806 of a endnode component 802. A component can be an IPSOE, switch, or router. All IPSOE and router components must have a network address. A media access point on a switch is also assigned a MAC address.

Each port of switch 810 does not have link layer address associated with it. However, switch 810 can have a media access port 814 that has a link layer address 816 and a network layer address 818 associated with it.

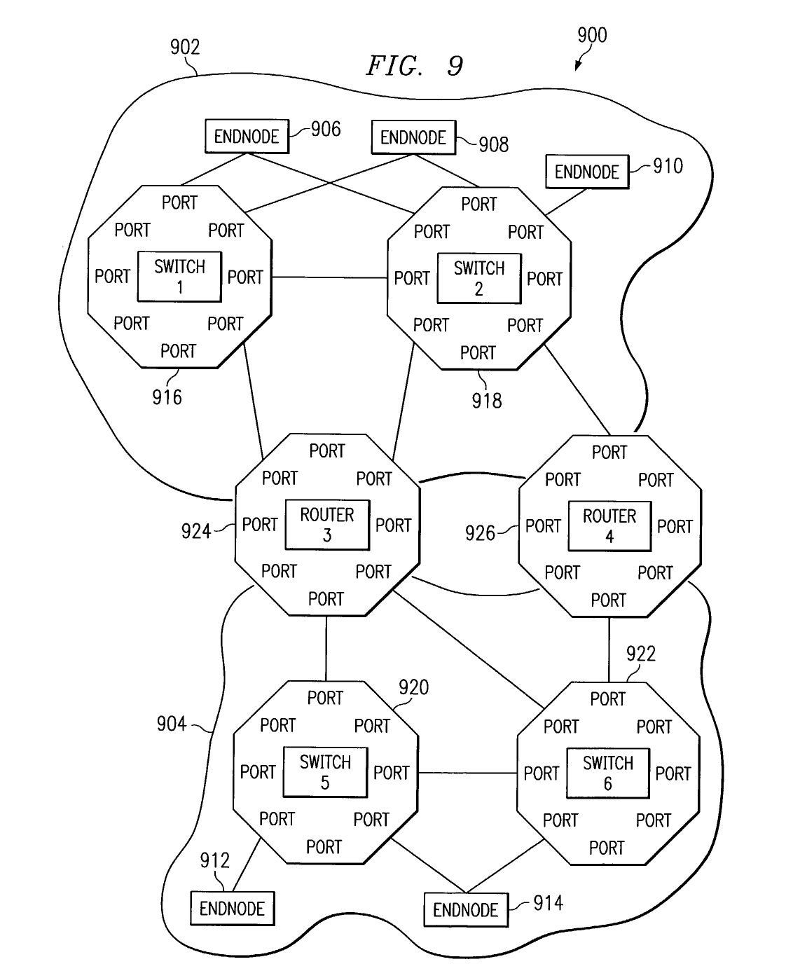

A portion of a distributed computer system in accordance with a preferred embodiment of the present invention is illustrated in FIG. 9. Distributed computer system 900 includes a subnet 902 and a subnet 904. Subnet 902 includes host processor nodes 906, 908, and 910. Subnet 904 includes host processor nodes 912 and 914. Subnet 902 includes switches 916 and 918. Subnet 904 includes switches 920 and 922.

Routers create and connect subnets. For example, subnet 902 is connected to subnet 904 with routers 924 and 926. In one example embodiment, a subnet has up to 216 endnodes, switches, and routers.

A subnet is defined as a group of endnodes and cascaded switches that is managed as a single unit. Typically, a subnet occupies a single geographic or functional area. For example, a single computer system in one room could be defined as a subnet. In one embodiment, the switches in a subnet can perform very fast wormhole or cut-through routing for messages.

A switch within a subnet examines the destination link layer address (e.g. MAC address) that is unique within the subnet to permit the switch to quickly and efficiently route incoming message frames. In one embodiment, the switch is a relatively simple circuit, and is typically implemented as a single integrated circuit. A subnet can have hundreds to thousands of endnodes formed by cascaded switches.

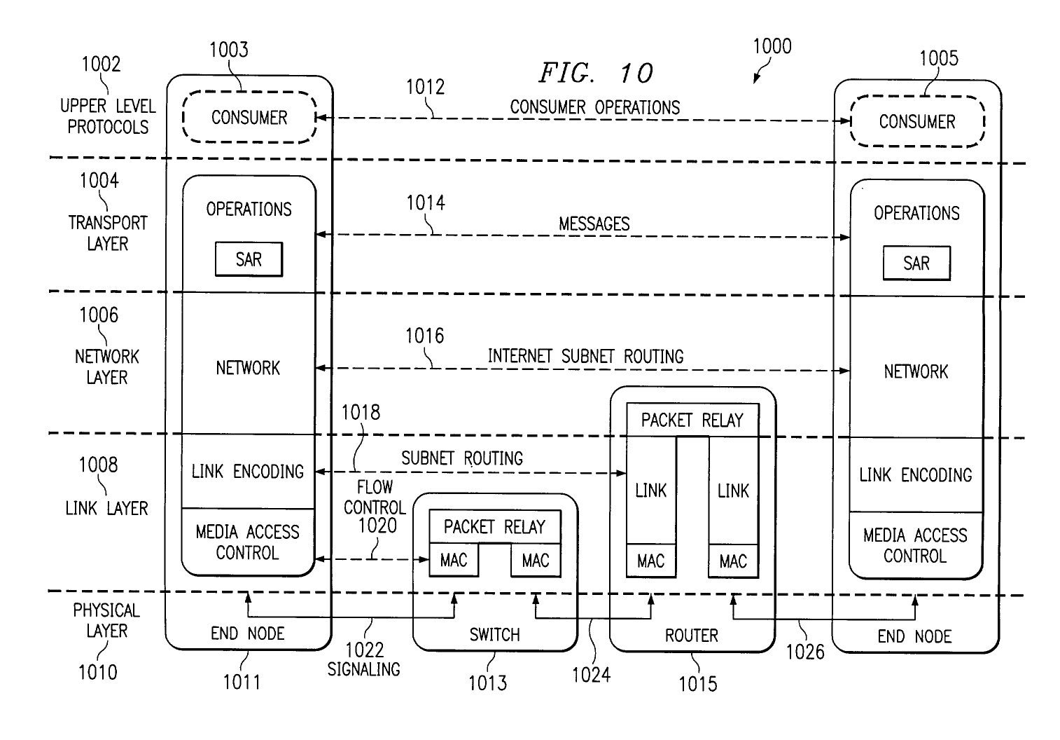

As illustrated in FIG. 10, for expansion to much larger systems, subnets are connected with routers, such as routers 924 and 926. The router interprets the destination network layer address (e.g. IP address) and routes the frame.

An example embodiment of a switch is illustrated generally in FIG. 3B. Each I/O path on a switch or router has a port. Generally, a switch can route frames from one port to any other port on the same switch.

Within a subnet, such as subnet 902 or subnet 904, a path from a source port to a destination port is determined by the link layer address (e.g. MAC address) of the destination host IPSOE port. Between subnets, a path is determined by the network layer address (IP address) of the destination IPSOE port and by the link layer address (e.g. MAC address) of the router port which will be used to reach the destination's subnet.

In one embodiment, the paths used by the request frame and the request frame's corresponding positive acknowledgment (ACK) frame is not required to be symmetric. In one embodiment employing oblivious routing, switches select an output port based on the link layer address (e.g. MAC address). In one embodiment, a switch uses one set of routing decision criteria for all its input ports. In one example embodiment, the routing decision criteria are contained in one routing table. In an alternative embodiment, a switch employs a separate set of criteria for each input port.

A data transaction in the distributed computer system of the present invention is typically composed of several hardware and software steps. A client process data transport service can be a user-mode or a kernel-mode process. The client process accesses IP Suite Offload Engine hardware through one or more queue pairs, such as the queue pairs illustrated in FIGS. 3A and 5. The client process calls an operating-system specific programming interface, which is herein referred to as “verbs.” The software code implementing verbs posts a work queue element to the given queue pair work queue.

There are many possible methods of posting a work queue element and there are many possible work queue element formats, which allow for various cost/performance design points, but which do not affect interoperability. A user process, however, must communicate to verbs in a well-defined manner, and the format and protocols of data transmitted across the IP Net fabric must be sufficiently specified to allow devices to interoperate in a heterogeneous vendor environment.

In one embodiment, IPSOE hardware detects work queue element postings and accesses the work queue element. In this embodiment, the IPSOE hardware translates and validates the work queue element's virtual addresses and accesses the data.

An outgoing message is split into one or more data frames. In one embodiment, the IPSOE hardware adds a, DDP/RDMA header, frame header and CRC, transport header and a network header to each frame. The transport header includes sequence numbers and other transport information. The network header includes routing information, such as the destination IP address and other network routing information. The link header contains the Destination link layer address (e.g. MAC address) or other local routing information.

If a TCP or SCTP is employed, when a request data frame reaches its destination endnode, acknowledgment data frames are used by the destination endnode to let the request data frame sender know the request data frame was validated and accepted at the destination. Acknowledgement data frames acknowledge one or more valid and accepted request data frames. The requester can have multiple outstanding request data frames before it receives any acknowledgments. In one embodiment, the number of multiple outstanding messages, i.e. Request data frames, is determined when a queue pair is created.

Referring to FIG. 10, a diagram illustrating one embodiment of a layered architecture is depicted in accordance with the present invention. The layered architecture diagram of FIG. 10 shows the various layers of data communication paths, and organization of data and control information passed between layers.

IPSOE endnode protocol layers (employed by endnode 1011, for instance) include an upper level protocol 1002 defined by consumer 1003, a transport layer 1004; a network layer 1006, a link layer 1008, and a physical layer 1010. Switch layers (employed by switch 1013, for instance) include link layer 1008 and physical layer 1010. Router layers (employed by router 1015, for instance) include network layer 1006, link layer 1008, and physical layer 1010.

Layered architecture 1000 generally follows an outline of a classical communication stack. With respect to the protocol layers of end node 1011, for example, upper layer protocol 1002 employs verbs to create messages at transport layer 1004. Transport layer 1004 passes messages (1014) to network layer 1006. Network layer 1006 routes frames between network subnets (1016). Link layer 1008 routes frames within a network subnet (1018). Physical layer 1010 sends bits or groups of bits to the physical layers of other devices. Each of the layers is unaware of how the upper or lower layers perform their functionality.

Consumers 1003 and 1005 represent applications or processes that employ the other layers for communicating between endnodes. Transport layer 1004 provides end-to-end message movement. In one embodiment, the transport layer provides four types of transport services as described above which include traditional TCP, RDMA over TCP, SCTP, and UDP. Network layer 1006 performs frame routing through a subnet or multiple subnets to destination endnodes. Link layer 1008 performs flow-controlled, error checked, and prioritized frame delivery across links.

Physical layer 1010 performs technology-dependent bit transmission. Bits or groups of bits are passed between physical layers via links 1022, 1024, and 1026. Links can be implemented with printed circuit copper traces, copper cable, optical cable, or with other suitable links.

Referring to FIG. 11, a diagram illustrating the operation of the Queue Pair look-up processing is depicted in accordance with the present invention. In the preferred implementation of the current invention a Queue Pair Context 1100 is used to maintain the upper level protocol (e.g. socket or iSCSI), queue pair, send work queue, receive work queue, transmission control protocol, and internet protocol state information. The QP number is segmented into two parts: a QP Context Table look-up portion and a QP number validation portion. In FIG. 11, each part is 16 bits. (Note: an implementation may apportion more bits to one part of the QP than the part of the QP other.) In FIG. 11, the QP Context Table Register 1118 maintains the starting address and length of the QP Context Table 1108. An IPSOE capable of supporting 64,000 simultaneous connections would require a QP Context Table 1108 with 64,000 entries.

The Nth QP Context Table Entry 1104 contains QP Context 1100. QP Context 1100 contains the upper level protocol (e.g. socket or iSCSI), queue pair, send work queue, receive work queue, transmission control protocol, and internet protocol state associated with the Nth QP Context Table Entry 1104. Included in the queue pair state of QP Context 1100 are QP N's Lower 16 bits 1114 and the QP Protocol Type 1122. The QP Protocol Type 1122 specifies the type of protocol currently in use by the QP. Valid QP Protocol Types include: traditional TCP/IP, traditional TCP/IPSec, SCTP, RDMA over TCP/IP, RDMA over TCP/IPSec, RDMA over SCTP, iSCSI over TCP/IP, and iSCSI over IPSec.

The field used to look-up the QP context depends on the QP Protocol Type. The following table defines which field is used as the QP context look-up for each QP Protocol Type.

| QP Protocol Type | Incoming Packet's Context Look-Up Field |
|---|---|
| TCP | N/A |
| TCP/IPSec | Security Parameter Index |
| SCTP | SCTP Verification Tag |
| RDMA over TCP/IP | Frame or Marker Key |
| RDMA over | Security Parameter Index |
| TCP/IPSec | |
| RDMA over SCTP | SCTP Verification Tag |
| iSCSI over | N/A |
| TCP/IP | |
| iSCSI over IPSec | Security Parameter Index |

For traditional TCP/IPSec, RDMA over TCP/IPSec, and iSCSI over IPSec, the context look-up field is the Security Parameter Index (SPI) contained in the IPSec header. During IPSec initialization, the lower 16 bits of the SPI are set to the next available value that is not in the Time Wait state, the lower 16 bits of the SPI are then stored in the QP Context associated with the SPI. (Initialization and tear-down is explained in more detail below.)

For RDMA over TCP/IP, the context look-up field is the frame or marker key (Key) contained in the frame or marker header. During RDMA initialization, the lower 16 bits of the Key are set to the next available value that is not in the Time Wait state, the lower 16 bits of the Key are then stored in the QP Context associated with the Key.

For SCTP and RDMA over SCTP, the context look-up field is the SCTP Verification Tag (Tag) contained in the SCTP header. During RDMA initialization, the lower 16 bits of the Tag are set to the next available value that is not in the Time Wait state, the lower 16 bits of the Tag are then stored in the QP Context associated with the Tag.

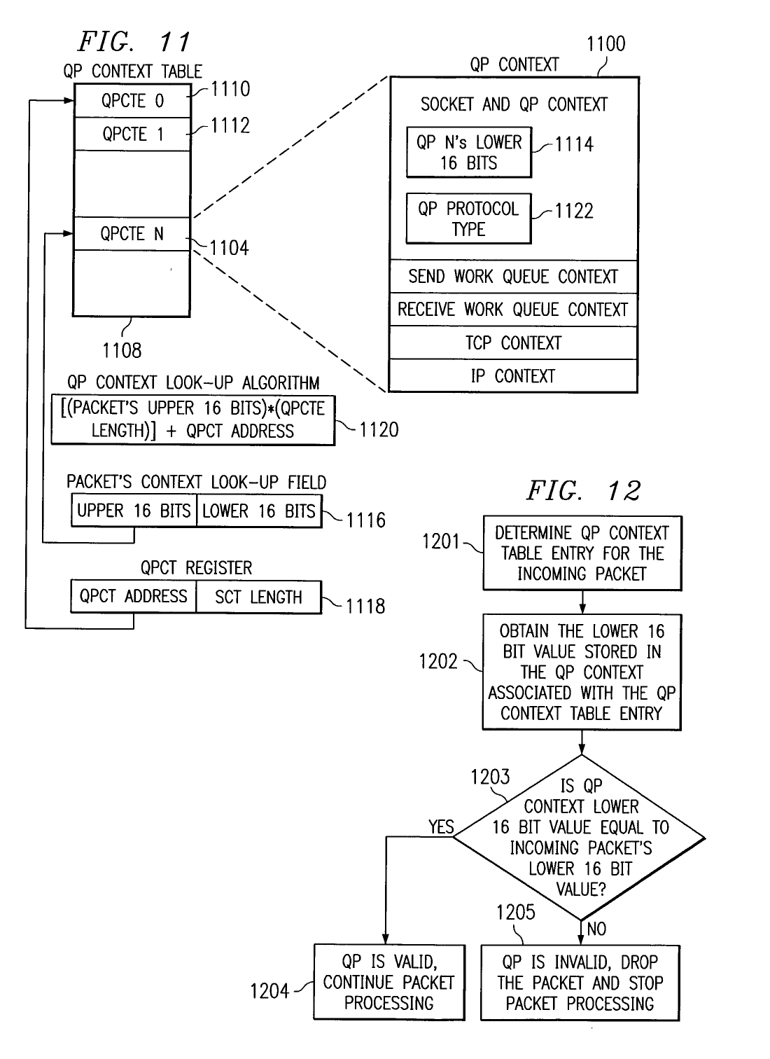

After initialization, the validation process is the same for the above protocols. FIG. 12 depicts a flowchart illustrating this validation process. The process begins by determining the QP Context Table Entry for the incoming packet (step 1201). This is accomplished by the QP Context look-up algorithm, in which the upper 16 bits of the incoming packet's context look-up field 1116 is multiplied by the QP Context Table Entry length. The result is added to the QP Context Table Address contained in the QP Context Table Register 1118. For the example in FIG. 11, the result is the address of the Nth entry 1104 in the QP Context Table 1108.

The next step is to obtain the lower 16 bit value 1114 stored in the QP Context 1100 associated with the QP Context Table Entry (i.e. Nth entry) (step 1202). The lower 16 bits of the incoming packet's context look-up field 1116 are compared with QP N's lower 16 bits 1114 stored in the QP Context 1100 to determine if they are equal (Step 1203).

If the values are equal, the QP is valid and packet processing and validation (e.g. TCP/IP quintuple validation) can continue (step 1204). If the values are not equal the QP is invalid, the packet is dropped, and processing is not continued (step 1205).

For traditional TCP/IP and TCP/IP over iSCSI, a hash function is used to determine the QP context address associated with an incoming packet. The hash function is performed over the IP quintuple: transport type, source port number, destination port number, source IP address, and destination IP address. If a collision exists for a specific hash function calculation, then the specific hash function points to a table containing one quintuple entry for each quintuple that has the same specific colliding hash value.

When a connection is torn down, the IPSOI consumer places the lower 16 bit value of the QP associated with the connection into the highest-value Time Wait state array (see below). An alternate implementation would place the connection's full QP number in the time wait state.

The IPSOI consumer maintains 7 arrays of QP lower 16 bit values for each QP: a 6 minute, 5 minute, 4 minute, 3 minute, 2 minute, 1 minute, and Available Value array. For example, QP lower 16 bit values in the 6 minute array have at most 6 minutes to go before they can be reused, those in the 5 minute array have at most 5 minutes before they can be used, etc. All QP lower 16 bit values in the Available Value array are available for immediate use. The highest-value array may be higher or lower, depending on the implementation. Also, the number of arrays, and the time interval between them, can be higher or lower, depending on the implementation.

If the alternate embodiment is implemented, in which the connection's full QP number is placed in the time wait state, the time arrays will contain the full QP values instead of just the lower 16 bit values.

The number of arrays and the time resolution of the arrays can be higher or lower than described above. Every 1 minute, the IPSOI consumer moves all QP lower 16 bit values in the M minute array to the M−1 minute array. When M−1 reaches zero, the QP lower 16 bit values in the M−1 array are placed in the Available Value array. Also, when M−1 reaches zero, if the Available Value array contains at least one QP lower 16 bit value, then the QP is placed in the Available QP array.

Before a connection is initialized, the IPSOI consumer selects and removes a QP from the Available QP array. It also selects and removes a lower order 16 bit value from the selected QP's Available Value array. If the Available QP array is empty, the IPSOI consumer must wait until it is non-empty.

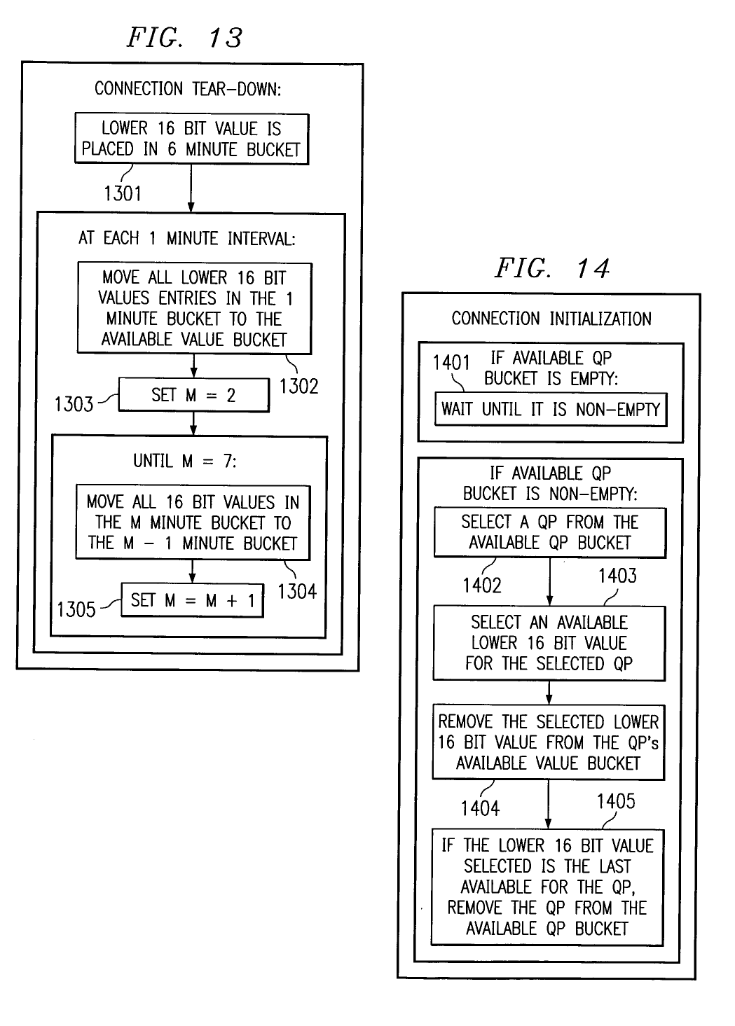

Referring to FIG. 13, a flowchart illustrating the process of connection tear-down is depicted in accordance with the present invention. At connection tear-down the IPSOI consumer places the lower 16 bit value of the QP associated with the torn-down connection into the 6 minute array (step 1301).

At each 1 minute interval for each QP move each lower 16 bit value entry in the QP's 1 minute array to the QP's Available Value array (step 1302), and set M equal to 2 (step 1303). Then do the following until M equals 7: a) Move all 16 bit values in the M minute array to the M minus 1 minute array (step 1304); and b) set M equal to M plus 1 (step 1305).

Referring to FIG. 14, a flowchart illustrating the process of the connection initialization is depicted in accordance with the present invention. At connection initialization, if the Available QP array is empty, wait until it is non-empty (step 1401). If the Available QP array is non-empty, select a QP from the Available QP array (step 1402), select an available lower 16 bit value for the selected QP (step 1403), and remove the selected lower 16 bit value from the QP's Available Value array (step 1404). Finally, if the lower 16 bit value selected is the last available for the QP, then remove the QP from the Available QP array (step 1405).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for looking up and virtualizing queue pairs used over a communication protocol, the method comprising the computer-implemented steps of:
initializing a communication connection, wherein specified lower bits of a queue pair context look-up field are set to a next available value in a array and then stored in a queue pair context;
validating an incoming data packet by comparing the value of the lower bits stored in the queue pair context with a corresponding lower bit value associated with the data packet;
if the corresponding lower bit values are equal, continuing processing of the data packet; and
if the corresponding lower bit values are unequal, ending processing of the data packet and disconnecting the queue pair.

2. The method according to claim 1, further comprising:
ending the communications connection, wherein the lower bit value used by the queue pair that has been disconnected is placed in the time wait state array.

3. The method according to claim 1, wherein the queue pair context look-up field is a security parameter index.

4. The method according to claim 3, wherein the communication protocol is one of the following:
TCP/IPSec;
RDMA over TCP/IPSec; and
iSCSI over IPSec.

5. The method according to claim 1, wherein the queue pair context look-up field is a frame key.

6. The method according to claim 5, wherein the communication protocol is RDMA over TCP/IP.

7. The method according to claim 1, wherein the queue pair context look-up field is a marker key.

8. The method according to claim 7, wherein the communication protocol is RDMA over TCP/IP.

9. The method according to claim 1, wherein the queue pair context look-up field is a verification tag.

10. The method according to claim 9, wherein the communication protocol one of the following:
SCTP; and
RDMA over SCTP.

11. A computer program product in a computer readable medium for use in a data processing system, for looking up and virtualizing queue pairs used over a communication protocol, the computer program product comprising:
first instructions for initializing a communication connection, wherein specified lower bits of a queue pair context look-up field are set to a next available value in a array and then stored in a queue pair context;
second instructions for validating an incoming data packet by comparing the value of the lower bits stored in the queue pair context with a corresponding lower bit value associated with the data packet;
if the corresponding lower bit values are equal, third instructions for continuing processing of the data packet; and
if the corresponding lower bit values are unequal, fourth instructions for ending processing of the data packet and disconnecting the queue pair.

12. The computer program product according to claim 11, further comprising:
fifth instructions for ending the communications connection, wherein the lower bit value used by the queue pair that has been disconnected is placed in the time wait state array.

13. The computer program product according to claim 11, wherein the queue pair context look-up field is a security parameter index.

14. The computer program product according to claim 13, wherein the communication protocol is one of the following:
TCP/IPSec;
RDMA over TCP/IPSec; and
iSCSI over IPSec.

15. The computer program product according to claim 11, wherein the queue pair context look-up field is a frame key.

16. The computer program product according to claim 15, wherein the communication protocol is RDMA over TCP/IP.

17. The computer program product according to claim 11, wherein the queue pair context look-up field is a marker key.

18. The computer program product according to claim 17, wherein the communication protocol is RDMA over TCP/IP.

19. The computer program product according to claim 11, wherein the queue pair context look-up field is a verification tag.

20. The computer program product according to claim 19, wherein the communication protocol one of the following:
SCTP; and
RDMA over SCTP.

21. A system for looking up and virtualizing queue pairs used over a communication protocol, the system comprising:
an initialization component for initializing a communication connection, wherein specified lower bits of a queue pair context look-up field are set to a next available value in a array and then stored in a queue pair context;
a validation component for validating an incoming data packet by comparing the value of the lower bits stored in the queue pair context with a corresponding lower bit value associated with the data packet;
a processor for processing of the data packet if the corresponding lower bit values are equal; and
a termination component for ending processing of the data packet and disconnecting the queue pair if the corresponding lower bit values are unequal.
